(19) United States
(12) Patent Application Publication
(10) Pub. No.: US 2026/0070599 A1
(43) Pub. Date: Mar. 12, 2026

(54) ELECTROMECHANICAL STEERING SYSTEM AND METHOD FOR OPERATING AN ELECTROMECHANICAL STEERING SYSTEM WITH REDUCED ENERGY FEEDBACK

(71) Applicants: thyssenkrupp Presta AG, Eschen (LI); thyssenkrupp AG, Essen (DE)

(72) Inventors: Dezsoe BAKOS, Feldkirch (AT); Tamás Gergely KÁROLY, Sennwald (CH); Jenoe GYOEKERES, Budapest (HU)

(73) Assignees: thyssenkrupp Presta AG, Eschen (LI); thyssenkrupp AG, Essen (DE)

(21) Appl. No.: 19/325,283

(22) Filed: Sep. 10, 2025

(30) Foreign Application Priority Data
Sep. 11, 2024 (BE) BE 2024/5614

(51) Int. Cl. B62D 1/04; B62D 5/04

(52) U.S. Cl. CPC B62D 1/04; B62D 5/0409

(57) ABSTRACT

An electromechanical steering system comprises a first actuator having a first electric motor and a first control unit, and a second actuator having a second electric motor and a second control unit, wherein the first electric motor can be operated in a motor mode or a generator mode depending on the driving situation, wherein the first actuator and the second actuator are communicatively connected to one another, and the second control unit is designed, in a generator mode of the first electric motor, to actuate the second electric motor in such a way that a current that is generated in a generator mode of the first electric motor is converted energetically by the second electric motor, in particular by influencing a Id current for the second electric motor specified by vector control. A method for operating such a steering system in a motor vehicle comprises generating a current in a generator mode of the first electric motor and energetically converting the generated current by the second electric motor.

### CROSS REFERENCE TO RELATED APPLICATION

This application is a U.S. Non-Provisional that claims priority to Belgian Patent Application No. BE 2024/5614, filed Sep. 11, 2024, the entire content of which is incorporated herein by reference.

### FIELD

The present disclosure relates to a method for operating an electromechanical steering system in a motor vehicle.

### BACKGROUND

In the prior art, such a method for a steer-by-wire steering system as an electromechanical steering system and a steer-by-wire steering system having a feedback actuator as the first actuator and a steering actuator as the second actuator is known, for example, from EP 4 273 025 A1.

When an electric motor of an actuator of the steering system is operated, a generator mode, in which electric currents are generated, is problematic because the DC voltage source and/or the connection to the DC voltage source of an on-board power supply system of a motor vehicle is not suitable or is no longer suitable for the reception of such generated currents, especially for cost reasons, and the generated currents can thus cause damage to electronic components. Conventional vehicle batteries, which are used, in particular, in motor vehicles with an internal combustion engine, are thus often suitable for receiving such generated currents. Newer designs of on-board power supply systems with a higher on-board power supply system voltage and the provision of the operating voltage via a drive battery in hybrid or electric vehicles require the intermediate connection of a DC/DC converter (DC: direct current), which is not designed to receive or feed back generated currents, especially for reasons of cost. This problem is also addressed in DE 10 2021 205 851 A1, wherein, in this document, it is proposed to switch on unnecessary consumers if feedback would cause an overvoltage in the on-board power supply system.

The disadvantage here is that, in this way, operation of an electromechanical steering system in a motor vehicle may depend, in particular, on how an on-board power supply system in a motor vehicle is operated.

Thus a need exists to provide an improved method for operating an electromechanical steering system and an improved electromechanical steering system. In particular, the intention is to prevent damage being caused by the generated electric currents in generator mode of an electric motor of an actuator of the steering system.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of an electromechanical steering system designed according to the invention.

FIG. 2 shows a flowchart, depicted in simplified fashion, for explaining an exemplary embodiment of a method for operating an electromechanical steering system, which is designed according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a method for operating an electromechanical steering system in a motor vehicle, wherein the steering system comprises a first actuator having a first electric motor and a second actuator having a second electric motor, wherein the first electric motor is operated in a motor mode or a generator mode depending on the driving situation. The invention also relates to an electromechanical steering system, which comprises a first actuator having a first electric motor and having a first control unit and a second actuator having a second electric motor and having a second control unit, wherein the first electric motor can be operated in a motor mode or a generator mode depending on the driving situation.

The proposed solution provides a method for operating an electromechanical steering system in a motor vehicle, in particular a method for operating a steer-by-wire steering system in a motor vehicle, wherein the steering system comprises a first actuator having a first electric motor and a second actuator having a second electric motor. The first electric motor is operated in a motor mode or a generator mode depending on the driving situation, wherein a current that is generated in a generator mode of the first electric motor is converted energetically by the second electric motor, wherein a torque to be provided by the second electric motor advantageously remains substantially unaffected. In particular, the first electric motor advantageously remains free of influences due to an additional ripple. Advantageously, a steering feeling for a driver thus advantageously remains essentially unchanged. A conversion of a current that is generated in a generator mode of the first electric motor is advantageously taken up by the second electric motor and thus advantageously does not load the on-board power supply system. Damage to electronic components connected to the on-board power supply system can thus advantageously be prevented by currents that are generated by the first electric motor. The electromechanical steering system is thus advantageously autonomous with regard to the handling of such currents that are generated in a generator mode and is, in particular, independent of a design of an on-board power supply system and the handling of generated currents on the on-board power supply system side. This also advantageously improves the usability of the electromechanical steering system in a variety of different vehicle models and vehicle types.

The first electric motor and the second electric motor are each designed, in particular, as a three-phase motor, more particularly as a permanent-magnet synchronous motor in each case. Provision can also advantageously be made for the second electric motor to be operated in a motor mode or a generator mode depending on the driving situation, wherein a current that is generated in a generator mode of the second electric motor is converted energetically by the first electric motor. In this case, too, the first electric motor is advantageously operated in such a way that the conversion of the generated current remains largely without influence on a torque to be provided by the first electric motor. In particular, both the first electric motor and the second electric motor can also be operated in a generator mode or in a motor mode, in particular also simultaneously, depending on the driving situation.

In particular, the energy for operating the first electric motor or the first electric motor and the second electric motor is provided via a DC/DC converter, in particular by a drive battery of a motor vehicle. The DC/DC converter ensures provision of the operating voltage required to operate the first electric motor or the first electric motor and the second electric motor. The DC/DC converter can advantageously be designed in a cost-effective manner because it does not have to be designed to convert or feed back currents that are generated by the electric motors of the steering system.

According to a preferred embodiment, provision is made, in the electromechanical steering system, for the first actuator to be a feedback actuator acting via a steering shaft on a steering handle and the first electric motor to be an electric motor of the feedback actuator. The second actuator is advantageously a steering actuator acting via a steering gear on steerable wheels of the motor vehicle, wherein the second electric motor is an electric motor of the steering actuator. In particular, this embodiment makes use of the fact that an electric motor of a steering actuator is operated predominantly in a motor mode during operation of a motor vehicle and is hardly operated in a generator mode, whereas an electric motor of a feedback actuator is often operated in generator mode.

In particular, however, one embodiment may also make provision, in the electromechanical steering system, for the first actuator to be a steering actuator acting via a steering gear on steerable wheels of the motor vehicle and for the first electric motor to therefore be an electric motor of the steering actuator. The second actuator is then advantageously a feedback actuator acting via a steering shaft on a steering handle and the second electric motor is thus an electric motor of the feedback actuator.

Another advantageous embodiment of the method makes provision for the first electric motor to be monitored by a first control unit for an occurrence of a generator mode. A generator mode of the first electric motor is more advantageously communicated to a second control unit of the second electric motor. The second electric motor is then advantageously actuated by the second control unit in a generator mode of the first electric motor in such a way that the current that is generated by the first electric motor is converted energetically by the second electric motor. The first actuator and the second actuator are thus advantageously connected to one another for signal exchange. The first control unit is, in particular, a control unit assigned to the first actuator, furthermore, in particular, a control unit assigned to the feedback actuator, and may be comprised, in particular, by a so-called power pack. The second control unit is, in particular, a control unit assigned to the second actuator, furthermore, in particular, a control unit assigned to the steering actuator, and may be comprised, in particular, by a so-called power pack. However, provision may also be made, in particular, for the first control unit and the second control unit to be comprised by a higher-level control unit. Monitoring the presence of a generator mode of an electric motor advantageously makes it possible for the other electric motor to be actuated directly so that a current that is generated in the generator mode is converted energetically thereby. It is thus advantageously possible to react particularly quickly to possible loading of the on-board power supply system caused by generated currents.

A check is further advantageously performed for the second electric motor to determine whether a present mode of the second electric motor permits an energetic conversion of a current that is generated by the first electric motor. Thus, in particular in the case of significant loading of the second electric motor, in particular when a high supporting torque is required by the second electric motor during operation, it may be the case that the additional energy of the generated currents cannot be converted energetically or at least cannot be converted energetically without negative effects on the operating behaviour of the second electric motor. Provision is therefore advantageously made for the current that is generated by the first electric motor to be energetically converted by the second electric motor when the present mode of the second electric motor permits the energetic conversion of the current that is generated by the first electric motor. This advantageously ensures normal operation of the electromechanical steering system.

Therefore, in the event that the present mode of the second electric motor does not permit the energetic conversion of the current that is generated by the first electric motor, provision is advantageously made for the current that is generated by the first electric motor to be converted energetically by the first electric motor, in particular without generating a torque that is perceptible to a vehicle user.

According to a particularly advantageous development of the method, the first electric motor is controlled by the first control unit by means of vector control, wherein a d-vector and a q-vector of a rotor-referred d/q system for the first electric motor are influenced by means of a first controller of the first control unit, in particular a PI controller (PI: proportional-integral). For such vector control, a mathematical conversion by means of a Clarke transformation and a subsequent Park transformation from a stator-referred three-phase system to the rotor-referred d/q system, in particular, is carried out in a known manner, wherein the d-vector and the q-vector are aligned orthogonally with respect to one another. As is customary in vector control, the q-vector is used to set a torque to be provided, with the d-vector influencing the magnetic flux density. The d-vector of the rotor-referred d/q system for the first electric motor is adapted, in particular increased, for the energetic conversion of a current that is generated by the first electric motor in generator mode. The d-vector is advantageously adapted in such a way that the generated current is completely or at least almost completely converted. The d-vector and thus the Id current is adapted, in particular, by means of the controller used for vector control. The q-vector and thus the Iq current are advantageously unaffected, such that a torque that is perceptible for a vehicle user is not generated by the conversion of the generated currents.

According to a particularly advantageous embodiment, the second electric motor is controlled by the second control unit by means of vector control, wherein a d-vector and a q-vector of a rotor-referred d/q system for the second electric motor are influenced by means of a second controller of the second control unit, in particular a PI controller. The d-vector of the rotor-referred d/q system for the second electric motor is in this case advantageously adapted, in particular increased, for the energetic conversion of a current that is generated by the first electric motor in generator mode. The magnetic flux density is thus advantageously influenced, which ultimately leads, in particular, to a conversion into thermal energy, wherein a torque to be provided by the second electric motor advantageously remains largely unaffected.

One advantageous development makes provision for the first electric motor to also be controlled by the first control unit by means of vector control. The d-vector of the rotor-referred d/q system for the first electric motor is advantageously increased for the energetic conversion of a current that is generated by the first electric motor in generator mode when a resulting dq-vector of the rotor-referred d/q system for the second electric motor reaches a rated phase current. If a resulting dq-vector of the rotor-referred d/q system for the second electric motor reaches a rated phase current, this means, in particular, that the present mode of the second electric motor does not sufficiently permit the energetic conversion of the current that is generated by the first electric motor. This may be the case, in particular, with steering manoeuvres with significant steering activity. In this case, therefore, a generated current is advantageously converted by the first electric motor. Damage to electronic components connected to the on-board power supply system caused by currents that are generated by the first electric motor in generator mode can thus advantageously even be avoided when the second electric motor is not or is not completely available for the conversion of these currents due to driving situation-dependent loading of the second electric motor. To test whether the present mode of the second electric motor permits an energetic conversion of a current that is generated by the first electric motor, the second electric motor advantageously provides a signal describing the present saturation of the second electric motor to the first electric motor. If a value of this signal is greater than a predefined threshold value, the first electric motor advantageously begins with the conversion of the current that is generated by the first electric motor, in particular at least corresponding to a portion not converted by the second electric motor.

Another advantageous embodiment makes provision for the controller to calculate the Id current required for reducing the current that is generated by the first electric motor and to adapt the d-vector accordingly. In particular, the Id current is the current with which current that is generated by the first electric motor is energetically converted or “consumed” through appropriate use in the second electric motor or in the first electric motor. Owing to the communicative connection between the first actuator and the second actuator, initially by means of the vector control, the Id current for the second electric motor can advantageously be determined accordingly and the second electric motor can be actuated accordingly. If the second electric motor is in saturation or the second electric motor is in saturation, the first electric motor is advantageously actuated accordingly using the vector control.

In order to solve the aforementioned object, an electromechanical steering system, in particular a steer-by-wire steering system, is also proposed, wherein the steering system comprises a first actuator having a first electric motor and having a first control unit and a second actuator having a second electric motor and having a second control unit. The first electric motor can be operated in motor mode or generator mode depending on the driving situation. Furthermore, provision is made for the first actuator and the second actuator to be communicatively connected to one another, and for the second control unit to be designed to actuate the second electric motor in a generator mode of the first electric motor in such a way that a current that is generated in a generator mode of the first electric motor is converted energetically by the second electric motor. Advantageously, an on-board power supply system in a motor vehicle is advantageously not loaded by currents that are generated by an electric motor of the steering system during operation of the steering system through the use of such a steering system. The electromechanical steering system is advantageously designed to be operated according to a method designed according to the invention. This results, in particular, in the features and advantages described in connection with the description of the method and the embodiments thereof.

One advantageous embodiment of the steering system makes provision for the first actuator to be a feedback actuator acting via a steering shaft on a steering handle and the second actuator to be a steering actuator acting via a steering gear on steerable wheels of the motor vehicle. In this embodiment, the first electric motor is accordingly an electric motor of the feedback actuator and the second electric motor is accordingly an electric motor of the steering actuator. In particular, this embodiment makes use of the fact that an electric motor of a steering actuator is operated predominantly in a motor mode during operation of a motor vehicle and is hardly operated in a generator mode, whereas an electric motor of a feedback actuator is often operated in generator mode. The additional ripple in the first electric motor and thus in the feedback actuator advantageously cannot be felt by a driver when operating the steering system in a motor vehicle. This means that the steering feeling will advantageously not change.

In particular, however, one embodiment may also make provision, in the electromechanical steering system, for the first actuator to be a feedback actuator acting via a steering gear on steerable wheels of the motor vehicle and for the first electric motor to therefore be an electric motor of the steering actuator. The second actuator is then advantageously a feedback actuator acting via a steering shaft on a steering handle and the second electric motor is thus an electric motor of the feedback actuator.

The first electric motor and the second electric motor are each designed, in particular, as a three-phase motor, more particularly as a permanent-magnet synchronous motor in each case. The first control unit and the second control unit are advantageously directly assigned to the respective electric motor. However, the first control unit and the second control unit may be, in particular, comprised by a higher-level control unit. The first electric motor and the second electric motor are advantageously controlled by means of vector control, wherein each of the electric motors is advantageously assigned a corresponding controller, in particular a PI controller.

The PI controller advantageously has a reference input that is dependent on the rotational speed of the electric motor in the event that the first electric motor is operating in a generator mode. A current that is actually provided in the on-board power supply system for the supply of energy to the electric motors of the steering system is advantageously calculated from the d-q voltage outputs of the PI controller and from the information relating to the d-q currents. The PI controller is advantageously designed to provide the Id current that is required to reduce the current that is generated regeneratively in the on-board power supply system by an electric motor in generator mode. This Id current is added to the Id reference output of the second control unit of the second electric motor. The second electric motor is then operated with the sum Id_ref, and thus the currents that are generated in generator mode are energetically converted, advantageously almost without influence on the torque to be provided by the electric motor.

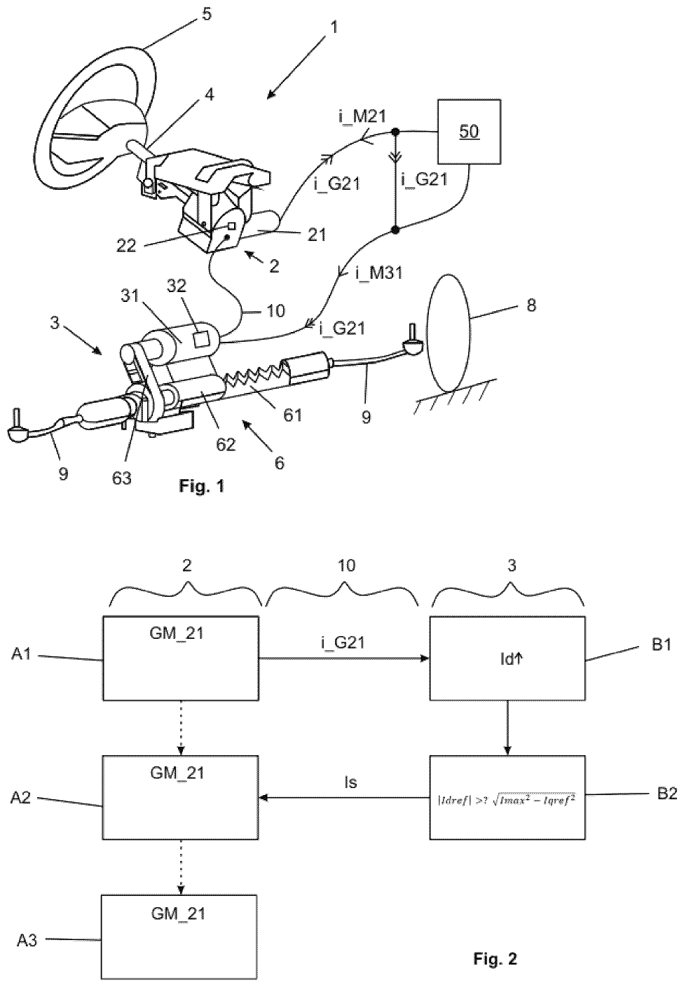

FIG. 1 depicts in a simplified manner an exemplary embodiment of an electromechanical steering system 1 designed according to the invention, which is designed as a steer-by-wire steering system in this exemplary embodiment. The steering system 1 comprises a first actuator 2 having a first electric motor 21 and having a first control unit 22 and a second actuator 3 having a second electric motor 31 and having a second control unit 32. In this exemplary embodiment, the first actuator 2 is a feedback actuator acting via a steering shaft 4 of the steering system 1 on a steering handle 5 connected to the steering shaft 4 in a rotationally fixed manner and the first electric motor 21 is a feedback actuator electric motor. In this exemplary embodiment, the second actuator 3 is a steering actuator acting via a steering gear 6 on steerable wheels 8 of the motor vehicle and the second electric motor 31 is a steering actuator electric motor. Both electric motors 21, 31 are three-phase motors, in particular permanent-magnet synchronous motors.

The first electric motor 21 is operated in a motor mode depending on the driving situation, in particular for generating an active counter-steering action against a steering input applied by a driver to the steering handle, or operated in a generator mode, in particular when a certain steering resistance is displayed towards a steering movement applied by a driver. The first actuator 2 having the first electric motor 21 is thus designed, in particular, to exert a torque or a steering resistance torque on the steering shaft 4, in particular for conveying a steering feeling that is perceptible for a driver of a motor vehicle.

The second electric motor 31 can also be operated fundamentally in a motor mode and a generator mode, wherein a generator mode rarely arises, for example when the steerable wheels assume a different wheel steering angle due to an obstacle. A motor mode of the second electric motor 31 is required in this case particularly when a detected steering specification, in particular a steering movement applied by a driver, must be converted to a corresponding wheel steering angle of the steered wheels 8. In order to convert a steering specification to a wheel steering angle of the steerable wheels 8, the second actuator 3 acts via the steering gear 6 on the steerable wheels 8.

Specifically, in this exemplary embodiment, provision is made for the second electric motor 31 of the second actuator 3 to act via a transmission belt 63 on a spindle drive 62, which is operatively connected to a coupling rod 61 formed as a rack. Appropriate actuation of the second electric motor 31 drives the spindle drive 62 for converting a steering specification to a steering movement of the steerable wheels 8. In this case, the second actuator acts via the spindle drive 62, which is driven by the second electric motor 31, on the coupling rod 61 and thus triggers a steering movement of the steerable wheels 8 of a motor vehicle, wherein the steerable wheels 8 in this exemplary embodiment are connected to the coupling rod 61 via track rods 9. The track rods 9 themselves are each connected to one steered wheel 8 in a known manner via steering knuckles.

The first electric motor 21 and the second electric motor 31 of the steering system 1 are connected via a DC/DC converter 50 to an on-board power supply system of a motor vehicle, wherein the energy required for a motor mode of the electric motors 21, 31 is provided via the DC/DC converter 50. A current flow i_M21 from the DC/DC converter 50 to the first electric motor 21 is thus shown symbolically in FIG. 1 for a motor mode of the first electric motor 21. A current flow i_M31 from the DC/DC converter 50 to the second electric motor 31 is also shown symbolically for a motor mode of the second electric motor 31.

The first electric motor 21 and the second electric motor 31 are respectively actuated based on vector control by means of the control units 22, 32 assigned to the electric motors 21, 31. For this purpose, the stator-referred three-phase system is transformed in a known manner to a rotor-referred d/q system, which is carried out using a Clarke transformation with subsequent Park transformation. The d-vector and q-vector thus obtained for the control of the respective electric motor 21, 31 are then adapted accordingly by means of a PI controller included in the respective control unit 22, 32 in order to implement a control specification. As usual, the torque to be provided by the respective electric motor 21, 32 is controlled by an adjustment of the q-value, while the d-value has an influence on the magnetic flux density.

The second control unit 32 is now designed to actuate the second electric motor 32 in a generator mode of the first electric motor 21 in such a way that a current i_G21 that is generated in generator mode of the first electric motor 21 is converted energetically by the second electric motor 32. For this purpose, the first actuator 2 is communicatively connected to the second actuator 3 via a signal line 10. The first electric motor 21 is monitored for the occurrence of a generator mode by the first control unit 22. A generator mode of the first electric motor 21 is then communicated to the second control unit 32 of the second electric motor 31, wherein the second electric motor 31 is actuated by the PI controller of the second control unit 32 in such a way that the Id current specified as part of the vector control for the second electric motor 31 is increased, this being carried out by appropriate adaptation of the d-vector, as a result of which the current i_G21 that is generated in generator mode of the first electric motor 21 is converted energetically by the second electric motor 31. As a result of the fact that only the d-vector, but not the q-vector, is adapted, the generated current i_G21 advantageously has no influence on a torque to be provided by the second electric motor 31. The current i_G21 that is generated by the first electric motor 21 is thus advantageously “combusted” in the second electric motor 31 and thus advantageously does not load the DC/DC converter 50 and not the on-board power supply system either. A direct current flow i_G21 from the first electric motor 21 to the second electric motor 31 is therefore shown symbolically in FIG. 1.

In principle, provision may accordingly be made for a current that is generated by the second electric motor 31 to be converted energetically by the first electric motor 21.

One advantageous exemplary embodiment of a method for operating an electromechanical steering system 1 in a motor vehicle is explained below with reference to FIG. 2, wherein the steering system 1 comprises a first actuator 2 having a first electric motor 21 and a second actuator 3 having a second electric motor 31, wherein the first electric motor 21 is operated in a motor mode or a generator mode GM_21 depending on the driving situation, wherein a current i_G21 that is generated in a generator mode GM_21 of the first electric motor 21 is converted energetically within the steering system 1. In particular, provision may be made for the steering-by-wire steering system 1 explained with reference to FIG. 1 to also be designed to be operated according to this method.

In FIG. 2, the blocks A1 to A3 shown on the left refer to the first actuator 2, which is, in particular, a feedback actuator, and the blocks B1 and B2 shown on the right refer to the second actuator 3, which is, in particular, a steering actuator. A signal line 10 is provided between the first actuator 2 and the second actuator 3 for communication between the first actuator 2 and the second actuator 3.

For block A1, provision is now made for the first electric motor 21 to be operated in a generator mode GM_21 and for the current i_21 to be generated. In particular, provision is made for the on-board power supply system, which supplies energy to the electric motors 21, 31, not to be designed to handle such generated currents or to feed them back to the energy source. The generator mode GM_21 of the first electric motor 21 is identified here by the first control unit 22 and this is communicated to the second control unit 32 and the generated current i_G21 is forwarded to the second actuator 3, wherein the second electric motor 31 is then actuated by the second control unit 32 in such a way that the current i_G21 that is generated by the first electric motor 21 is converted energetically by the second electric motor 32, in particular substantially without affecting a torque to be provided by the second electric motor.

To this end, in this exemplary embodiment, provision is made for the second electric motor 31 to be controlled by the second control unit 32 by means of vector control, wherein a d-vector and a q-vector of a rotor-referred d/q system for the second electric motor 31 are influenced by means of a PI controller of the second control unit 32, and wherein the d-vector of the rotor-referred d/q system for the second electric motor 32 is increased for the energetic conversion of the current i_G21 that is generated by the first electric motor 21, which is now executed in block B1. The PI controller in this case advantageously comprises a speed-dependent reference input if the first electric motor 21 of the steering system 1 is operating in generator mode. The actual battery current, that is to say the current that is provided by a battery connected to the on-board power supply system and the generated current i_G21 is advantageously calculated from the d-q voltage outputs of the PI controller and from the feedback of the d-q currents. The PI controller then advantageously calculates the Id current that is required to reduce the current i_G21 generated by the first electric motor 21. This Id current is advantageously added to the Id reference output, wherein the second electric motor 31 is then actuated with the sum Id_ref. Since the q-value remains unaffected by this, there are almost no effects on the torque to be provided by the second electric motor 21.

In block B2, provision is now made for there additionally to be a check performed for the second electric motor 31 to determine whether a present mode of the second electric motor 31 permits an energetic conversion of a current i_G21 that is generated by the first electric motor 21. If the present mode of the second electric motor 31 permits the energetic conversion of the current i_G21 that is generated by the first electric motor 21, the current i_G21 that is generated by the first electric motor 21 is further converted energetically by the second electric motor 31, as previously described (block B1). To test whether the present mode of the second electric motor 31 permits the energetic conversion of the current i_G21 that is generated by the first electric motor 21, the second electric motor 31 advantageously provides a signal describing the current saturation of the second electric motor 31 to the first electric motor 21. If a value of this signal is greater than a predefined threshold value, the first electric motor begins to compensate. In particular, it is also possible to check whether a resulting dq-vector of the rotor-referred d/q system for the second electric motor 31 reaches a rated phase current. In this case, it is possible, in particular, to further check whether the following condition is met:

$$\vert {i}_{dref} \vert > \sqrt{{i}_{MAX}^{2} - {i}_{qref}^{2}} .$$

A current component Is that cannot be converter due to a present mode of the second electric motor 31 is then determined in the second block by the second control unit 32 to give:

$${i}_{s} > \vert {i}_{dref} \vert - \sqrt{{i}_{MAX}^{2} - {i}_{qref}^{2}} .$$

Corresponding communication takes place between the second control unit 32 and the first control unit 22, wherein provision is then made, in block A2, for the energetic conversion of the current i_G21 that is generated by the first electric motor 21 in generator mode GM_21, which in this embodiment has already been reduced accordingly to the current Is, for the d-vector of the rotor-referred d/q system for the first electric motor 21 to be adapted, in particular increased, by means of the PI controller of the first control unit 22 in such a way that the current Is is “burned off”, that is to say converted, in the first electric motor 21 in a corresponding manner, as described for block B2.

In block A3, an analogous test to block B2 is provided.

The exemplary embodiments illustrated in the figures and explained in conjunction therewith serve to explain the invention and have no limiting effect thereon.

### LIST OF REFERENCE SIGNS

1 Steering system
2 First actuator
21 First electric motor
22 First control unit
3 Second actuator
31 Second electric motor
32 Second control unit
4 Steering shaft
5 Steering handle
6 Steering gear
61 Coupling rod (rack)
62 Spindle drive
63 Transmission belt
8 Steerable wheel
9 Track rod
10 Signal line
50 DC/DC converter
GM_21 Generator mode
i_G21 Current generated by the first electric motor (21) in generator mode
i_M21 Current supplied via the DC/DC converter for the motor mode of the first electric motor (21)
i_M31 Current supplied via the DC/DC converter for the motor mode of the second electric motor (31)

1. A method for operating an electromechanical steering system in a motor vehicle, wherein the steering system comprises a first actuator having a first electric motor and a second actuator having a second electric motor, wherein the method comprises:
operating the first electric motor in a motor mode or a generator mode depending on the driving situation; and
energetically converting a current that is generated in a generator mode of the first electric motor by the second electric motor.

2. The method according to claim 1, wherein the first electric motor is monitored by a first control unit for the occurrence of a generator mode, a generator mode of the first electric motor is communicated to a second control unit of the second electric motor, and the second electric motor is actuated by the second control unit in a generator mode of the first electric motor in such a way that the current that is generated by the first electric motor is converted energetically by the second electric motor.

3. The method according to claim 1, wherein a check is performed for the second electric motor to determine whether a present mode of the second electric motor permits an energetic conversion of a current that is generated by the first electric motor, wherein the current that is generated by the first electric motor is energetically converted by the second electric motor when the present mode of the second electric motor permits the energetic conversion of the current that is generated by the first electric motor.

4. The method according to claim 3, wherein the current that is generated by the first electric motor is energetically converted by the first electric motor when the present mode of the second electric motor does not permit the energetic conversion of the current that is generated by the first electric motor.

5. The method according to claim 4, wherein the first electric motor is controlled by the first control unit by vector control, wherein a d-vector and a q-vector of a rotor-referred d/q system for the first electric motor are influenced by a first controller of the first control unit, wherein the d-vector of the rotor-referred d/q system for the first electric motor is increased for the energetic conversion of a current that is generated by the first electric motor in generator mode.

6. The method according to claim 1, wherein the second electric motor is controlled by the second control unit by vector control, wherein a d-vector and a q-vector of a rotor-referred d/q system for the second electric motor are influenced by a second controller of the second control unit, wherein the d-vector of the rotor-referred d/q system for the second electric motor is increased for the energetic conversion of a current that is generated by the first electric motor in generator mode.

7. The method according to claim 6, wherein the d-vector of the rotor-referred d/q system for the first electric motor is increased for the energetic conversion of a current that is generated by the first electric motor in generator mode when a resulting dq-vector of the rotor-referred d/q system for the second electric motor reaches a rated phase current.

8. The method according to claim 7, wherein the controller calculates the Id current that is required to reduce the current that is generated by the first electric motor and adapts the d-vector accordingly.

9. The method according to claim 1, wherein energy for operating the first electric motor is provided via a DC/DC converter.

10. The method according to claim 1, wherein the first actuator is a feedback actuator acting via a steering shaft on a steering handle and the second actuator is a steering actuator acting via a steering gear on steerable wheels of the motor vehicle.

11. An electromechanical steering system, comprising:
a first actuator having a first electric motor and a first control unit; and
a second actuator having a second electric motor and a second control unit;
wherein the first electric motor can be operated in a motor mode or a generator mode depending on the driving situation;
wherein the first actuator and the second actuator are communicatively connected to one another, and the second control unit is designed, in a generator mode of the first electric motor, to actuate the second electric motor in such a way that a current that is generated in a generator mode of the first electric motor is converted energetically by the second electric motor.

12. The steering system according to claim 11, wherein the first actuator is a feedback actuator acting via a steering shaft on a steering handle and the second actuator is a steering actuator acting via a steering gear on steerable wheels of the motor vehicle.
